(19) United States
(12) Patent Application Publication
(10) Pub. No.: US 2011/0099070 A1
(43) Pub. Date: Apr. 28, 2011

(54) Method of Advertising

(75) Inventor: James Eliason, West Des Moines, IA (US)

(73) Assignee: Twittad, Urbandale, IA (US)

(21) Appl. No.: 12/910,049

(22) Filed: Oct. 22, 2010

Related U.S. Application Data
(60) Provisional application No. 61/254,089, filed on Oct. 22, 2009.

(51) Int. Cl. G06Q 30/00

(52) U.S. Cl. 705/14.58

(57) ABSTRACT

A system is provided for providing location-based coupons, promotions and advertisements to a mobile device. A mobile application is provided that identifies a consumer's location based on the consumer's use of location-tagging applications, typically a social media application such as Twitter. Promotions and coupons are provided to the mobile device that is relevant to the consumer's physical location.

This application claims priority to provisional application Ser. No. 61,254,089, which is incorporated herein by reference in its entirety.

### BACKGROUND OF THE INVENTION

1. Field of the Invention

The present invention relates in general to a method of promotion and advertisement on a mobile device. In particular, the present invention relates to a method of direct advertising to consumers through a mobile device based on the person's real-time geographic location.

2. Background

Mobile devices have become a platform for delivering a nearly endless variety of information to the consumer, wherever the consumer carries the device. The information can be customized to the consumer's particular preferences. Advertisements and coupons can be sent directly to a mobile device to be readily available to the consumer.

Social media websites such as Twitter and Facebook offer users the ability to post status updates or tweets, and these updates or tweets may be posted via a mobile application on a mobile device. Social media sites have developed applications that tie posts, tweets, or updates to latitude and longitude of the mobile device being used by the poster, thus enabling real-time, physical location of the user to be tied to their posts, tweets, and updates. For example, Twitter's Geolocation API links a user's Tweet or post to the location of that user. Foursquare also has a location feature that identifies the physical location of the user once the user checks in at a location like a restaurant or store.

Consumers like to have current, relevant information delivered directly to their mobile device. The location-tagging application provide a basis for identifying the location of a consumer and enables content to be sent directly to the mobile device that is timely and relevant to the consumer's current location.

### SUMMARY OF THE INVENTION

The method of advertising of the present invention couples the location stamps of social media applications with retailers. A mobile application is provided that brings together retailers and consumers. The location of a communication device is identified when a user of Twitter or the like posts, tweets, or the like. The mobile application then provides coupons, deals, promotions or other information from retailers located in the vicinity of the consumer to the consumer's mobile device.

Accordingly, it is an object of the present invention to provide a system for location-based advertising and promotion.

It is a further object of the invention to provide a system for delivering customized advertising, coupons, and promotions to a mobile device based on the location of the mobile device.

### BRIEF DESCRIPTION OF THE DRAWINGS

FIG. 1 is a block diagram of the location-based advertising system of the present invention.

FIG. 2 is a block diagram of the location-based advertising system of the present invention.

### DETAILED DESCRIPTION OF THE INVENTION

### Method Overview

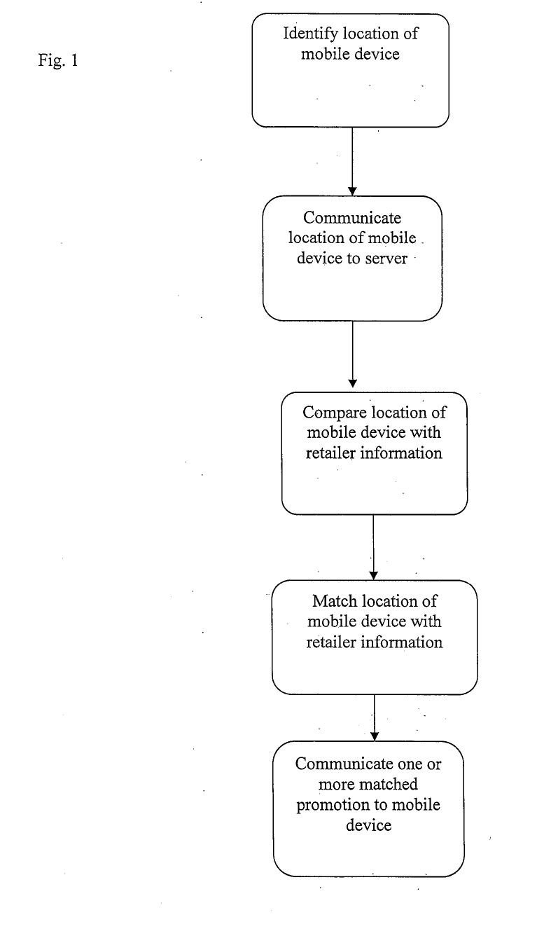

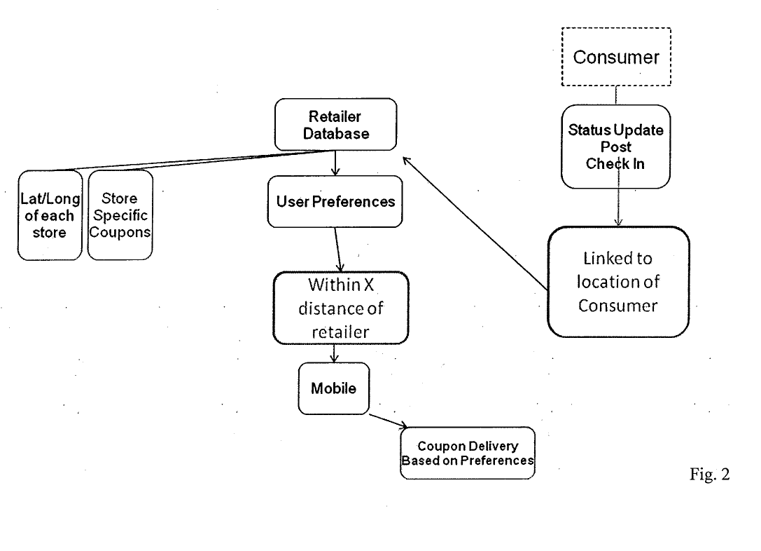

As seen generally in FIGS. 1-2, the present invention is a method of location based advertising or marketing. A retailer server contains information about advertisers and may include information about the physical location of each retail outlet, store, or otherwise of each advertiser and coupons, promotions, deals and other advertisements.

The software of the present invention is installed or configured on a mobile device. The mobile communication device is able to establish a connection with one or more networks and send and receive data. The software interfaces with one or more retailer servers.

A consumer provides a status update, tweets, posts or checks in via a social media application such as Twitter, Facebook, or Foursquare using a mobile device such as a cell phone. Any mobile application with location-tagging capabilities will be understood by one of skill in the art to be in the scope of this invention. The post, update, etc is linked to the physical location (i.e., latitude and longitude) of the mobile device. The software identifies the physical location of the consumer and the software interfaces with the advertiser server. The software securely connects with one or more servers associated with the retailers that contain information about the location and promotions of the retailers. The location of the consumer is matched with retailers and one or more retailer promotions are identified. The matched promotions are sent to the mobile device. One of skill in the art will identify any available means of communication of the promotion to the mobile device, including push notification, email, text message, voicemail, or pop-up message.

Coupons, promotions, deals and other advertisements that from advertisers that have been matched to the consumer's location are sent to the consumer's mobile device. The consumer is then able to redeem the coupons, etc. at the retailer. The coupon may be redeemed in any manner, including showing the coupon displayed on the mobile device to the retailer, scanning a bar code displayed on the mobile device at the retailer, providing a code for the retailer to use to redeem the coupon, or use of a kiosk to print the coupon. This invention may reduce the amount of paper that retailers use on coupons or direct mail pieces.

The deals or coupons are delivered to consumers on their mobile device based on their location. The proximity of the retailer to the consumer may be, by way of example, within one mile of the location of the consumer. The invention is not limited to any particular distance from the consumer to the retailer. Consumers are push-notified based on their use of other mobile applications that tag location, such as Twitter and Foursquare. The coupons, deals, promotions and advertisements are pushed to the mobile device in response to a location-tagged post.

Using the mobile device, consumers can indicate preferences to customize the coupons and promotions sent to the mobile device. These preferences include particular stores that they would like to receive promotions or coupons from, types of products or services they would like information or coupons about, and profile information such as address, date of birth, gender, profession, etc. Thereafter, whenever a user posts a social network status update, the latitude and longitude of the user at the time of the update triggers coupon or promotion delivery from retailers within a certain distance from the user.

For example, if a Twitter user has indicated preferences of receiving coupons from Large Grocery Store, when the user posts a tweet, he will automatically receive promotions or coupons from any Large Grocery Stores located within a designated distance from the user at the time of the update on the user's handheld device.

In another embodiment, a user of a handheld device can receive coupons or promotions when located near chosen retailers by downloading an application to the handheld device and running the application. In this embodiment, there is no need for a user to actively post a status update. The application identifies the location of the mobile device periodically or at all times, and there is no need for a social media post to link to the location of the device. The consumer opens the application interface at any time and will have immediate access to coupons or promotions offered by retailers located within a specified distance of the consumer's location.

For example, the consumer selects a preference for Big Coffee Shop. The application monitors the real-time location of the consumer. When the consumer is located within a specific distance of Big Coffee Shop, the application transmits coupons for Big Coffee Shop to the consumer's mobile device.

In another embodiment, the mobile application has keyword or key phrase identification functionality and customizes the coupons or promotions provided to the consumer based on this keyword identification. For example, if a consumer tweets that he wants coffee, the mobile application recognizes the keyword “coffee” and sends the consumer deals for coffee retailers located in the vicinity of the consumer.

These and other objects of the present invention will become apparent to those skilled in the art upon reference to the following specification, drawings, and claims.

The present invention intends to overcome the difficulties encountered heretofore.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

1. A method of providing location-based advertising to a consumer comprising:
a. providing a mobile device with an integrated application for communicating with one or more retailer information server;
b. identifying the geographic location of the mobile device;
c. comparing the geographic location of the mobile device with data on the retailer server;
d. matching retailers from with the location of the mobile device; and
e. communicating at least one promotion from the matching retailer to the mobile device.
